(19) United States
(12) Patent Application Publication
(10) Pub. No.: US 2008/0270900 A1
(43) Pub. Date: Oct. 30, 2008

(54) DEVICE, METHOD AND COMPUTER PROGRAM PRODUCT FOR SWITCHING A DEVICE BETWEEN APPLICATION MODES

(76) Inventor: Martin M.R. WEZOWSKI, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/760,843

(22) Filed: Jun. 11, 2007

Related U.S. Application Data
(60) Provisional application No. 60/914,391, filed on Apr. 27, 2007.

(51) Int. Cl. G06F 3/01

(52) U.S. Cl. 715/702

(57) ABSTRACT

A method, computer program product, and a digital device comprising a control unit arranged to control at least a first and a second application, a physical user interface comprising a first set of functional input elements, and when the device is running the first application, the physical user interface comprises a first set of functions associated with the functional input elements, an illuminating arrangement comprising at least one light source, and a dedicated part of the physical user interface that is activated and illuminated when the second application is opened in the device, displaying a second set of functions associated with a second set of functional input elements.

### CROSS REFERENCE TO RELATED APPLICATION

This application claims priority under 35 U.S.C. §119 to U.S. Provisional Application No. 60/914,391, filed Apr. 27, 2007, the entire disclosure of which is incorporated herein by reference.

### FIELD OF THE INVENTION

The present invention relates to a device, method and computer program product for switching a device between at least two application modes. Especially, the invention relates to switch between at least two application modes that put the device into two different function designs.

### BACKGROUND

Today the usage of a mobile phone as a camera is increasing enormously and the market provides a huge amount of mobile phones with which one can operate numerous applications. An example of an application well used is the camera application. The quality of the pictures is constantly improved and the low budget phones today provide a quality of the pictures with 1-2 mega pixels adding to that the usage of mobile devices as cameras is increased at an enormous rate. In order to facilitate the usage of the phone as a camera different solutions have been provided, such as a shortcut button for a camera application arranged on the mobile device that when pressed the mobile device changes from phone mode to camera mode. In an existent solution the keypad shortcut buttons, such as shortcut buttons placed below the display, changes functions when the mobile device is going from phone usage to camera usage during change of applications. Other applications function in a similar way, such as mp3-application or the like. As the telephone switches from one application to another the user of the device today may have to explore menus in order to operate the application which is inconvenient and often results in that the user uses merely the basic functions.

### SUMMARY OF THE INVENTION

The invention relates to a device, computer program and a method for using a digital device that can be used for at least two applications as stated in independent claims 1, 14 and 18.

The invention relates to a digital device comprising a control unit arranged to control at least a first and a second application, a physical user interface comprising a first set of functional input elements, wherein said first set of functional input elements is associated with a first set of functions when the digital device is running the first application, an illuminating arrangement comprising at least one light source, and a dedicated part of the physical user interface that is activated and illuminated when the second application is opened in the device, displaying a second set of functions associated with a second set of functional input elements.

Furthermore, an embodiment discloses a digital device wherein the dedicated part comprises a navigation area with a touch sensitive strip.

The touch sensitive strip may be placed under a glass cover next to a display.

In addition, the second set of functional input elements may be shown as icons at positions of the touch sensitive strip.

An embodiment discloses a digital device, wherein the touch sensitive strip has the function of a scroll bar.

An embodiment discloses a digital device, wherein the first set of functional input elements is the same as the second set of functional input elements.

An embodiment discloses a digital device, wherein a first set of functional input elements is a keypad.

An embodiment discloses a digital device, wherein the dedicated part comprises buttons.

An embodiment discloses a digital device, wherein the dedicated part is placed in or at the keypad.

Furthermore, the dedicated part may further comprise specific buttons of the keypad.

In an embodiment are the specific buttons illuminated by means of diodes and/or light guides.

An embodiment discloses a digital device, wherein icons are shown on or at the buttons.

An embodiment discloses a digital device, wherein the device is a mobile telecommunication device, and the second application is a camera application.

The invention further relates to a method for switching a digital device with at least a first and a second application installed thereon from a first application mode into a second application mode comprising the steps of indicating a switch of application; signalling a control unit in the digital device that the second application is selected, activating the second application arranged in the digital device by means of the control unit; activating an illumination arrangement controlled by the control unit arranged in the digital device, thereby displaying a set of function elements associated with the second application arranged on a physical user interface of the digital device.

Furthermore, an embodiment discloses a method, wherein the step of indicating a switch is performed by pressing an activation element arranged on the physical user interface of the digital device.

In addition, the step of activating an illuminating arrangement may further comprise to illuminate a dedicated part of the physical user interface arranged as a touch screen arrangement.

The step of activating an illuminating arrangement may further comprise to illuminate a dedicated part of the physical user interface arranged as specific buttons of a keypad of said device.

An embodiment discloses a computer program product executed on a digital device according to what is stated above and performing the method as disclosed above.

In order to provide a more user friendly user interface of a digital device elements associated with functions of an application is illuminated when the application is initiated, thereby providing a digital device that visually displays the functions of the second application. A user would strongly benefit from informative illumination or any kind of display telling what new actions/features can be triggered from the mobile device keypad or any kind of mobile device surface.

### BRIEF DESCRIPTION OF THE DRAWINGS

The features, objects, and further advantages of this invention will become apparent by reading this description in conjunction with the accompanying drawings, in which reference numerals refer to like elements and in which:

FIG. 1 shows a schematic overview of a digital device;

FIG. 2 shows an overview of a digital device in a second application mode;

FIG. 3 shows an embodiment of a digital device wherein touch screen parts are protected by glass covers;

FIG. 4 is an enlarged view of a physical user interface of a digital device with second application icons have been activated and illuminated;

FIG. 5 is a side view of a digital device; and

FIG. 6 is a schematic block diagram of a method for switching from a first application to a second application in the digital device.

### DETAILED DESCRIPTION OF EMBODIMENTS

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The present invention is described below with reference to block diagrams and/or flowchart illustrations of methods, apparatus (systems) and/or computer program products according to embodiments of the invention. It is understood that several blocks of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described herein as employed in and with a digital device such as a wireless communications device, also denoted a mobile device. In the context of the invention, the mobile device may e.g. be a mobile phone, a PDA (Personal Digital Assistant) or any other type of portable computer such as laptop computer. Furthermore, the invention is described as adapted for selection of one out of a plurality of simultaneously detected communications networks. In this context, a communications network may e.g. be an IEEE 802.11 type WLAN, a WiMAX, a HiperLAN, a Bluetooth LAN, or a cellular mobile communications network such as a GPRS network, or a third generation WCDMA network. Given the rapid development in communications, there will of course also be future type wireless communications networks with which the present invention may be embodied, but the actual design and function of the network is not of primary concern for the invention, which involves the actual process of selection of one out of a plurality of accessible networks.

For a mobile device only capable of communicating within cellular networks, the invention may be implemented as an embodiment for selecting one out of a plurality of cellular networks. If the mobile device is also capable of communicating in a WLAN, the invention may also be implemented as an embodiment for selecting one out of a plurality of WLANs. For a mobile device capable of communicating in a WLAN, but not in a cellular mobile communications network, e.g. a portable computer, the invention may also be implemented as an embodiment for selecting one out of a plurality of WLANs. For the sake of simplicity, though, the following description is focused on the application of the invention in a mobile phone, which is the hitherto best known mode of operation.

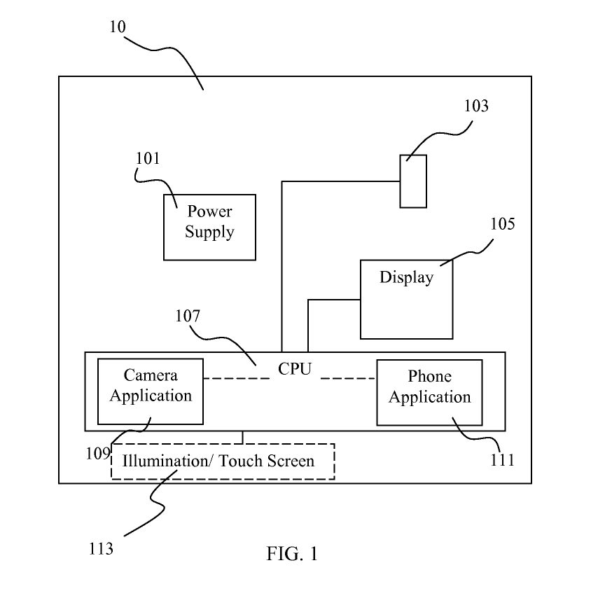

FIG. 1 discloses a schematic overview of an embodiment. A digital device 10, such as a wireless communications device, wireless media player device, or the like, comprises a power supply such as a battery arranged to supply power to all elements in the device 10, at least one input element 103 arranged to indicate a selection/indication or the like, such as a button, a display 105 arranged to display data, a central control unit 107, such as a CPU, arranged with a first application 111 and a second application 109, in the illustrated example, a phone and a camera application. However, it should be noted the number of application may be as many as the digital device may hold limited by the performance of the digital device. The operator of the device may indicate by, for example, using the input element 103 that the device should change application. The CPU 107 receives a signal from the input element 103 and switches application from a first application to a second application. When the CPU 107 switches to a different application, functions not active in the first application mode are activated either as new input elements or the same input elements providing different functions.

In an embodiment the new functions are displayed to the user by illuminating 113 certain symbols indicating the new function of the input element or by activating and illuminating 113 a touch sensitive area arranged on the digital device. The illumination/touch activation may be controlled by software detecting when different applications are opened installed on the CPU 107.

It should be understood that the switching from one application mode to another may be indicated in may different way, such as opening an application from a menu list, removing a camera lens cover, voice initiated or the like.

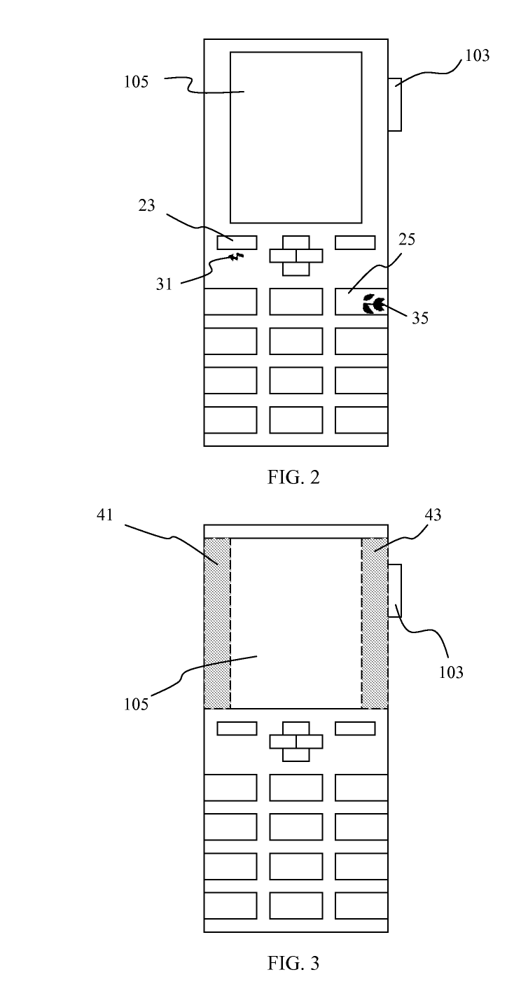

In FIG. 2 an embodiment of the invention is shown. A device 10 comprises a number of input elements 21, 23, 25 and a display 105. In a first application state the functions of the input elements are the following: first input element 21 switches the application to a second application, second input element 23 is a shortcut to a menu, third input element 25 is a dial “3”. As the first input element 21 is pressed the device changes application and thereby the functions of the input elements changes as well. The alternative function of the first input element is to take a snap shot, function of the second input element 23 may change to flash on/off and the third input element 25 may change to auto focus on/off. As shown in the illustrated example the mobile phone is in an illuminated state, that is, the camera state displaying the camera functions illuminates the flash symbol 31, the auto focus symbol 35 of the buttons.

Thus, in an embodiment, “the Cyber-shot illumination” is placed in or at the keypad at specific buttons. The specific buttons may be comprised in the normal keypad. The specific buttons will turn blue when the camera application is opened to indicate only those buttons useful for the camera mode. Suitably, icons are shown on or at the buttons. To achieve this effect diodes and light guides may be used. The normal figure symbols 0 to 9, * and #, are placed at the side on the same buttons or on the surface in the space between the buttons.

FIG. 3 shows one embodiment of the present invention, wherein a navigation area 41, 43 with “the Cyber-shot illumination” is placed on both sides of the display 105 hidden under an optional glass cover until the camera application is opened with no illumination on keypad. However, a combination with illumination of the keypad as well as the navigation area is also possible. That is, when in its first application mode, the phone mode, the digital device 10 is displaying and in an embodiment illuminating merely the functions of that application and the indications of the functions of the second application are darkened/invisible to the human eye resulting in that the display 105 is framed of darkened sides 41, 43. However, when the initiation button 103 is pressed the digital device switches from a first application mode to a second application mode, illuminating the second application functions.

FIG. 4 illustrates an embodiment of the invention wherein the display 105 and the navigation areas 41 and 43 have been enlarged. In the illustrated example a glass covers is arranged to cover the navigation areas 41, 42. The glass cover may be a permanent arrangement, that is, it is possible to register pressure applied by a user through said glass, appearing as part of a frame surrounding the display when not illuminated.

As the digital device has switched from a first application, in the example phone application mode, to a second application, in the example camera application mode, the new functions are illuminated. FIG. 4 illustrates when the digital device has been activated in the camera application mode, wherein the navigation areas 41, 43 change from inactive state to active state, displaying functions, such as flash, auto focus, zoom in/out, red eye reduction, etc accessible by touching a touch area of the navigation area. In an embodiment merely the icons are illuminated wherein the glass is darkened.

Thus, the navigation area comprises a touch sensitive strip placed under the optional glass. The color of the navigation area will turn blue (commonly used for shortcuts in camera functionality) to achieve camera look and feel. Suitably, icons related to the camera application are shown at positions of the strip. At the same time the touch sensitive strip is energized and may be actuated by the user.

In other applications, the touch sensitive strip may have the function of a scroll bar. This may be useful e.g. when the display is showing a scrollable web page and the like.

A touch sensitive strip or area may be placed at other positions than around the display, for example as camera buttons on the sides of the device.

Further embodiments include combinations of the embodiments above.

The same principle can be used in any kind of digital device having a physical user interface that can be changed depending on application of the device, such as Walkman phones, messaging, language input and more. In the example of the Walkman embodiment the digital device is first used as a phone displaying functions of a phone device and when Walkman ear phones are plugged in the digital device the digital device switches into a Walkman mode displaying new different functions either at existent keypad or at new illuminated buttons, or displayed icons at an touch sensitive area of the device. It should here be noted that the touch sensitive area may or may not be separated from a regular display area of the device.

In an embodiment, a device being in a first operational mode, such as telephone mode, changes to a second operational mode in which appearances change or buttons change functions when an indication is performed or indicated. Such indications may be a received position from GPS, time of day, light/sound conditions of the surrounding, the weather/temperature. The indication of switching functional mode may further be when an element is connected to the device, such as an external flashlight, a video cable, an external mobile printer or the like.

That is, in the example of connecting a video cable to the device, the device switches from its first mode appearance into a second mode changing the device into a remote control, wherein buttons/touch areas of the device gets illuminated displaying playing/recording functions for playing/recording audio/video remotely.

It should be understood that the digital device may comprise different illumination arrangements. For example, the digital device may comprise an illumination arrangement for a first application illuminating certain function elements associated with the first application and a second illumination arrangement arranged to illuminate a second set of function elements when the second application is activated. Thus, in an embodied example of the digital device the digital device is illuminated in, for example, a first color displaying a first set of functional elements relating to a first application and a second color displaying a second set of functional elements relating to a second application, wherein the elements may or may not be the same physical element. The arrangements may comprise a number of LEDs arranged in the digital device.

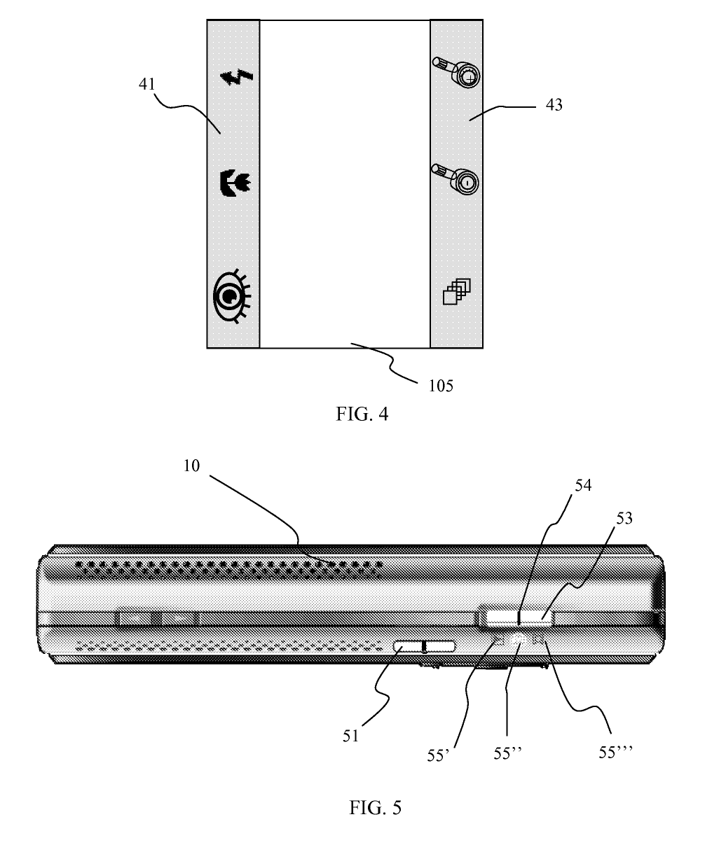

FIG. 5 shows an embodiment of a digital device comprising a physical user interface used in a camera application placed on the side of the digital device 10. The interface comprises a shutter key 51 that when pressed initiates the camera application of the digital device 10. This button 51 may get illuminated when the camera application is initiated for a short period or as long as the application is active. This button may also be used to turn off the application. The physical user interface may further comprise a selection switch 53 comprising an indicator 54, wherein the switch 53 is used to switch between different modes of the application. In the illustrated example the user may switch between Video 55′″/Still 55″ View 55′-mode of a camera application. The icons 55 illustrating the different modes may be illuminated when selected as well as the indicator 54 selecting the icon mode.

In an embodiment when the camera is under manual control all icons 55 are lit, including the indicator 54 of the switch 53. If the camera is launched by an application that only allows still picture, then only that icon is lit. The switch 53 is unlit to signal that it is not active in this mode.

In an embodiment, all the details could be lit with the same LED to indicate manual control, and unlit when software controlled.

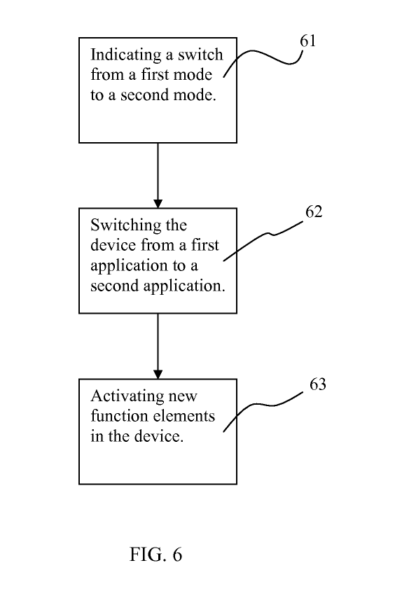

In FIG. 6, the method of activating a second application arranged in a digital device is shown.

The digital device is running a first application such as being in a telephone application state.

In step 61, an indication that a second application should be initiated is indicated. This indication may be performed manually by pressing a button, or by fulfilling an external requirement such as hooking up an external device to the digital device, received position from GPS, time of day, light/sound conditions of the surrounding, the weather/temperature, or the like. The indication triggers a signal that is sent to a central control unit of the digital device.

In step 62, the central control unit receives the indication and switches from the running first application to the second application, i.e., the digital device switches from a first application mode to a second application mode. The different modes may as stated above include telephone mode, camera mode, mp3 mode, remote control mode, and the like.

In step 63, a first set of functional elements associated with the first application is thereby switched to a second set of functional elements associated with the second application. The first set may in an embodiment be arranged as a keypad but might as well be icons on a touch screen, voice commands with indications thereof, movement registrations with indications thereof or the like. The second set may in an embodiment be arranged as the same elements or different elements. For example, the first set may be a keypad and the second set a touch screen or any possible combination. As the central control unit switches from the first application to the second application the functional elements of the second application are activated and illumination of the indications of the functions of the elements is initiated by an illumination arrangement controlled by the central control unit. Thereby, the user can easily operate the digital device being in a second application mode.

The foregoing has described the principles, preferred embodiments and modes of operation of the present invention. However, the invention should be regarded as illustrative rather than restrictive, and not as being limited to the particular embodiments discussed above. It should therefore be appreciated that variations may be made in those embodiments by those skilled in the art without departing from the scope of the present invention as defined by the following claims.

1. A digital device comprising:
a control unit arranged to control at least a first and a second application,
a physical user interface comprising a first set of functional input elements, wherein said first set of functional input elements is associated with a first set of functions when the digital device is running the first application,
an illuminating arrangement comprising at least one light source, and
a dedicated part of the physical user interface that is activated and illuminated when the second application is opened in the device, displaying a second set of functions associated with a second set of functional input elements.

2. A digital device as claimed in claim 1, wherein the dedicated part comprises a navigation area with a touch sensitive strip.

3. A digital device as claimed in claim 2, wherein the touch sensitive strip is placed under a glass cover next to a display.

4. A digital device as claimed in claim 2, wherein the second set of functional input elements are shown as icons at positions of the touch sensitive strip.

5. A digital device as claimed in claim 2, wherein the touch sensitive strip has the function of a scroll bar.

6. A digital device as claimed in claim 1, wherein the first set of functional input elements is the same as the second set of functional input elements.

7. A digital device as claimed in claim 1, wherein a first set of functional input elements is a keypad.

8. A digital device as claimed in claim 1, wherein the dedicated part comprises buttons.

9. A digital device as claimed in claim 7, wherein the dedicated part is placed in or at the keypad.

10. A digital device as claimed in claim 7, wherein the dedicated part further comprises specific buttons of the keypad.

11. A digital device as claimed in claim 10, wherein the specific buttons are illuminated by means of diodes and/or light guides.

12. A digital device as claimed in claim 8, wherein icons are shown on or at the buttons.

13. A digital device as claimed in claim 1, wherein the device is a mobile telecommunication device, and the second application is a camera application.

14. A method for switching a digital device with at least a first and a second application installed thereon from a first application mode into a second application mode comprising the steps of:
indicating a switch of application;
signalling a control unit in the digital device that the second application is selected,
activating the second application arranged in the digital device by means of the control unit;
activating an illumination arrangement controlled by the control unit arranged in the digital device, thereby displaying a set of function elements associated with the second application arranged on a physical user interface of the digital device.

15. A method according to claim 14, wherein the step of indicating a switch is performed by pressing an activation element arranged on the physical user interface of the digital device.

16. A method according to claim 14, wherein the step of activating an illuminating arrangement further comprises to illuminate a dedicated part of the physical user interface arranged as a touch screen arrangement.

17. A method according to claim 14, wherein the step of activating an illuminating arrangement further comprises to illuminate a dedicated part of the physical user interface arranged as specific buttons of a keypad of said device.

18. A computer program product stored on a machine readable medium which, when executed by a digital device, carries out the method of claim 14.
